(19) United States
(12) Patent Application Publication
(10) Pub. No.: US 2011/0093538 A1
(43) Pub. Date: Apr. 21, 2011

(54) COLLABORATIVE CALENDAR AND WORKFLOW MANAGEMENT

(75) Inventors: ROBERT C. WEIR, Westford, MA (US); BARRY E. WILLNER, Briarcliff Manor, NY (US); EDITH H. STERN, Yorktown Heights, NY (US); PATRICK J. O'SULLIVAN, Dublin (IE)

(73) Assignee: INTERNATIONAL BUSINESS MACHINES CORPORATION, ARMONK, NY (US)

(21) Appl. No.: 12/579,603

(22) Filed: Oct. 15, 2009

(51) Int. Cl. G06F 15/16

(52) U.S. Cl. 709/205; 709/206

(57) ABSTRACT

Collaborative calendar and workflow management that includes receiving, by a processing device, a workflow of a user comprising workflow tasks, accessing a calendar of the user by the processing device, and inserting, by the processing device, calendar entries of the user and the workflow tasks together in the calendar of the user.

### BACKGROUND

Aspects of the present invention relate to calendar management, and more specifically to collaborative calendar and workflow management.

Currently, many people are generally busy with activities and tasks that are ongoing and/or scheduled to happen in the future. The use of a calendar is a common way to help a person manage their various activities. Further, workload systems that include tasks that the person may be involved with also provide management of tasks related to the person. Calendaring is a common, powerful, useful interface to interacting with a person's daily tasks. Workflow systems such as an IBM® Websphere® Process Server provide the ability to describe workflows (IBM and Web Sphere are registered trademark of International Business Machines Corporation in the United States, other countries, or both). For example, participants in the workflow “logon” to a human task center to see what work they need to do and when they need to do it. A person may also have activities scheduled in a calendar program. Therefore, a person has to look at both their calendar and the workflow system to identify all tasks that they may need to do. This is inconvenient and inefficient.

### BRIEF SUMMARY

According to one aspect of the present invention, a method, operable on a server, for collaborative calendar and workflow management includes receiving, by the server, a workflow of a user comprising workflow tasks, accessing a calendar of the user by the server, and inserting, by the server, calendar entries of the user and the workflow tasks together in the calendar of the user.

According to another aspect of the present invention, a processing device for collaborative calendar and workflow management includes a network interface, the network interface being configured to receive and send information to a workflow system, and a processor, the processor configured to receive a workflow of a user comprising workflow tasks, access a calendar of the user, and insert calendar entries of the user and the workflow tasks together in the calendar of the user.

According to a further aspect of the present invention is included a computer program product comprising a computer readable storage medium having computer readable program code embodied therewith, the computer readable storage medium including computer readable program code configured to receive a workflow of the user comprising workflow tasks, computer readable program code configured to access a calendar of a user by the server, and computer readable program code configured to insert calendar entries of the user and the workflow tasks together in the calendar of the user.

### BRIEF DESCRIPTION OF THE DRAWINGS

Aspects of the present invention are further described in the detailed description which follows in reference to the noted plurality of drawings by way of non-limiting examples of embodiments of the present invention in which like reference numerals represent similar parts throughout the several views of the drawings and wherein:

FIG. 1 is a diagram of a system for collaborative calendar and workflow management according to an exemplary embodiment of the present invention;

FIG. 2 is a flowchart of a process for collaborative calendar and workflow management according to an exemplary embodiment of the present invention;

FIG. 3 is a flowchart of a process for collaborative calendar and workflow management according to another exemplary embodiment of the present invention;

FIG. 4 is a flowchart of a process for collaborative calendar and workflow management according to a still further exemplary embodiment of the present invention; and

FIG. 5 is a flowchart of a process for collaborative calendar and workflow management according to a still further exemplary embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments according to the present invention provide a user's calendar entries and their workflow tasks together within a calendar application allowing the user to view all their entries and tasks simultaneously. A business analyst or integration developer or both may create a workflow. This may be done with a high level tool like Websphere Business Modeler, an integration development tool like Websphere Integration Developer (WID) or both tools. This business workflow may be represented in a standards based language such as, for example, business process execution language (BPEL). A user interface to the steps in the workflow may be specified in a standards based way such as, for example, Java Server Pages (JSP). Users participating in the workflow might be specified in a directory such as, for example, an IBM Domino directory, or one following the Lightweight Directory Access Protocol (LDAP) standard. Embodiments according to the present invention, allow a user to look at a calendar to see his normal entries such as meetings or time allocated to mail as well as his workflow steps. A processing device may access the user's calendar and write data into the calendar representing workflow task entries of the user. The calendar may be a database on the processing device (e.g., server). When the user loads their client calendar software (e.g., Microsoft® Outlook, Lotus® Notes®, etc.), the user's calendar entries and workflow tasks may be presented together on the client device as the client device loads the calendar entries from the processing device (Microsoft is a trademark of Microsoft Corporation in the United States, other countries or both; Lotus and Notes are registered trademarks of International Business Machines in the United States, other countries or both). The processing device may update both the user's calendar entries and workflow tasks real-time dues to additions, deletions, rescheduling, status changes, etc. occur.

According to embodiments of the present invention, any time in a calendar program that may not otherwise be allocated for an activity or task may be made available for workflow steps. To help illustrate the present invention, the following example is provided. Assume that a person (Edie) is a credit manager participating in a mortgage processing workflow. There may be the following example calendar entries in her calendar:

“8:30 a.m.-9:30 a.m. Risk management meeting for department 3L, conference 22 in building G”

“9:30 a.m.-10:30 a.m. Participation in mortgage processing workflow”

Edie may gain access to her calendar by first logging on. Once logged on, she then sees the entries posted above. After attending the risk management meeting, she opens the participation entry and is presented with a list of credit histories to evaluate. A new screen may come up with the following exemplary list:

“Edie's Tasks

| | |
|---|---|
| Pick | Evaluate credit Barry Willner |
| Pick | Evaluate credit Rob Weir |
| Pick | Evaluate credit Pat O'Sullivan” |

The task list presented to Edie may be a prioritized list of tasks to be accomplished within a specific block of time. Edie may then select one of the picks, evaluate the credit history, indicate that the evaluation is done and completed, and then return again to the task screen. The completed task may now be missing from the screen or denoted as completed and removed later. Further, new tasks may have been added. The workflow instance that Edie processed may cause other processing or actions to occur such as, for example, a programmatic interaction (e.g. “update Customer Information Control System (CICS)”) to be initiated, or the workflow instance may now appear on the task list of another user. The other user may also use a calendar-based interface or may be using a legacy “human task center” interface. Any programmatic interaction may be a workload or workflow system being updated and running a next task on the list.

In embodiments according to the present invention, any task that may not be done by Edie in one time block (e.g., 8:30 a.m.-9:30 a.m.), may be made available in the next time block scheduled for workflow participation. Further, according to embodiments of the present invention, scheduling of time for workflow may be based on an expected time to complete each of the steps of a particular task. In addition, according to embodiments of the present invention, the expected times for the job steps may be communicated in metadata associated with the process. This metadata may come from the modeler or integration designer (i.e., predetermined) or input at the deployment (i.e., customized at instance of workflow) or any other time, and may be discovered from the running process or fed back from a monitor tool (e.g., tool that monitored user and has data regarding specific times a user takes to perform certain tasks). Therefore, according to embodiments of the present invention, there may be several ways to estimate how long it may take to perform a particular workflow task. The feedback may include specific times that a user takes to perform specific tasks. This information may be used to more efficiently identify an appropriate time slot in a user's calendar for a given workflow task.

According to embodiments of the present invention, the scheduling of the workflow tasks may be dependent on at least one priority associated with a workflow or a workflow instance. For example, priority may be associated with the workflow overall, or priority may be associated with individual workflow tasks. In the previous example, the mortgage approval workflow might have different priorities associated with different processing stages, based on service level agreements, customer satisfaction goals, regulatory requirements, etc. Moreover, in other embodiments according to the present invention, a communication from the workflow system to the calendar system may be based on any of many different ways such as, for example, Simple Mail Transfer Protocol (SMTP), Simple Object Access Protocol (SOAP), Remote Procedural Call (RPC), sending a message, using Remote Method Invocation (RMI), using Internet Inter-Orb Protocol (IIOP), using RMI/IIOP, making a web service call, directly manipulating the data/metadata in the calendaring database or file system, directly manipulating the data/metadata associated with the workflow system, etc.

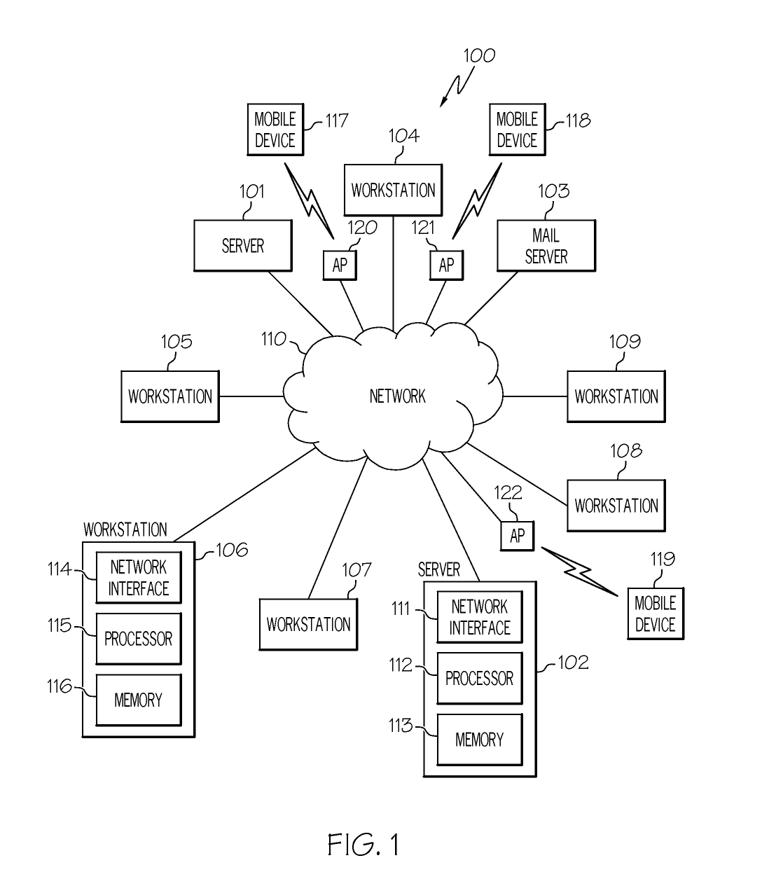

FIG. 1 shows a diagram of a system for collaborative calendar and workflow management according to an exemplary embodiment of the present invention. A system 100 may include one or more servers 101, 102, one or more mail servers 103, one or more wireless devices 117-119, and one or more workstations 104-109, where the servers 101, 102, wireless devices 117-119, and workstations 104-109 may be interconnected via a network 110. The wireless devices 117-119 may access the network 110 via one or more access points 120-122 or by any other method. The wireless devices 117-119 may be any type of wireless device such as, for example, a mobile phone, a personal digital assistant (PDA), a portable game system, a laptop computer, etc. The network 110 may be the Internet, an intranet, a local area network, a wide area network, or any other type of network. Each server 101, 102, 103 may include a network interface 111, a processor 112, a memory 113, and other elements normally associated with a server. Similarly, each workstation 104-109 may include a network interface 114, a processor 115, and memory 116, and other items normally associated with a workstation. A processor 112 of each server 101, 102, 103 or a processor 115 of each workstation 104-109 may execute software and/or be configured to determine a security risk for the user based on the activities of the user and set a security policy for the user based on the security risk.

A network interface 111 of each server 101, 102, 103 or a network interface 114 of each workstation 104-109 may be configured to receive and send information to a workflow system. A processor 112 of each server 101, 102, 103 or a processor 115 of each workstation 104-109 may be configured to receive a workflow of a user comprising workflow tasks, access a calendar of the user, and insert calendar entries of the user and the workflow tasks together in the calendar of the user. The workflow tasks of the user may be received from a workflow system. A processor 112 of each server 101, 102, 103 or a processor 115 of each workstation 104-109 may be configured to insert the workflow tasks in time slots in the calendar not allocated to the calendar entries. A processor 112 of each server 101, 102, 103 or a processor 115 of each workstation 104-109 may also be configured to send an updated status of one or more workflow tasks on the calendar to a workflow system that generated each workflow task. A processor 112 of each server 101, 102, 103 or a processor 115 of each workstation 104-109 may further be configured to receive a request to open one of the workflow tasks inserted in the calendar and send further details related to the one workflow task to a client device of a user.

Moreover, according to embodiments of the present invention, a processor 112 of each server 101, 102, 103 or a processor 115 of each workstation 104-109 may be configured to receive information of completion of one of the workflow tasks and notify a workflow system that generated the one workflow task of the completion. A processor 112 of each server 101, 102, 103 or a processor 115 of each workstation 104-109 may also be configured to remove the one of the workflow tasks from the calendar and/or show completed status on the calendar responsive to receiving information of the completion of the one of the workflow tasks. A processor 112 of each server 101, 102, 103 or a processor 115 of each workstation 104-109 may further be configured to reschedule one of the workflow tasks to a different time slot in the calendar responsive to a time slot for the one of the workflow tasks expiring before completion of the one of the workflow tasks.

In addition, according to embodiments of the present invention, a processor 112 of each server 101, 102, 103 or a processor 115 of each workstation 104-109 may be configured to schedule a time slot on the calendar for each of the work tasks based on an expected time to complete each specific work task. A processor 112 of each server 101, 102, 103 or a processor 115 of each workstation 104-109 may also be configured to receive metadata containing the expected time for each work task where the metadata may be associated with each workflow task. As noted previously, the metadata maybe generated by a modeler/designer of the work flow, customized and generated at deployment of the work flow, or generated from feedback from monitoring a user assigned the work task. The scheduling of the workflow tasks may be dependent on at least one priority associated with the workflow. As noted previously, the communication to the calendar system from the workflow system may be based on at least one of SMTP, SOAP, a RPC, sending a message, using RMI, using HOP, making a web service call, directly manipulating data/metadata in a database of the calendar system or directly manipulating data/metadata associated with the workflow system.

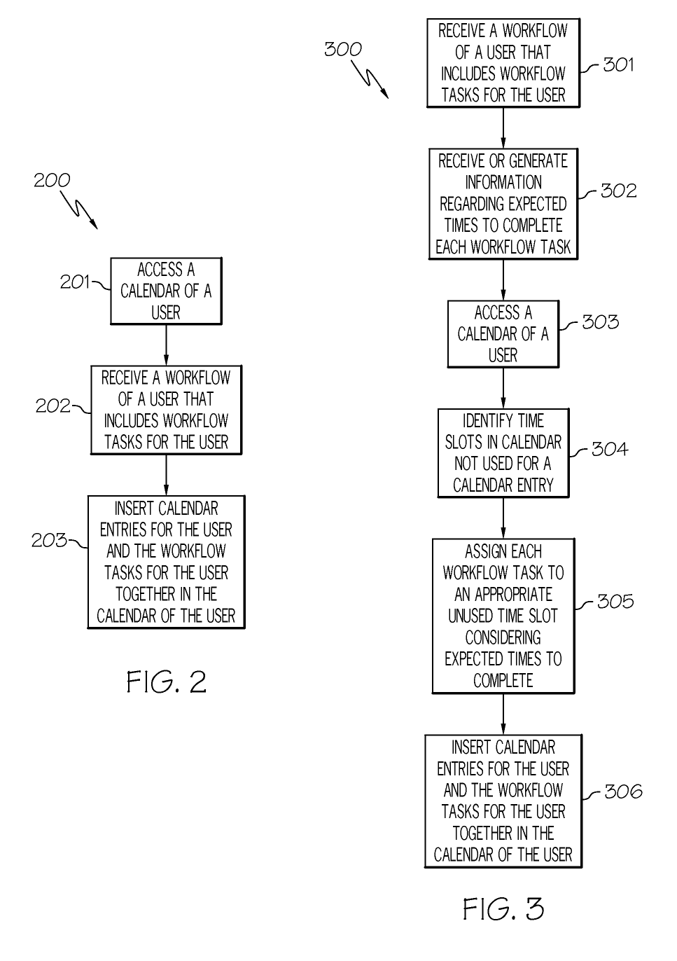

FIG. 2 shows a flowchart of a process for collaborative calendar and workflow management according to an exemplary embodiment of the present invention. In the process 200, in block 201, a calendar of a user may be accessed. In block 202, a workflow of a user may be received that includes workflow tasks for the user. In block 203, calendar entries for the user and the workflow tasks for the user may be inserted together in the calendar of the user. Therefore, a user may merely review his calendar and be presented with his calendar entries and workflow tasks together. The presentation of the workflow tasks may allow selection of a task by the user to begin performance on. The selection by the user of a workflow task may trigger a series of steps, activities, actions, etc. that may need to be performed for completion of the workflow task. The selection of a workflow task may also trigger the sending to the user of additional information related to the workflow task for presentation to the user.

FIG. 3 shows flowchart of a process for collaborative calendar and workflow management according to another exemplary embodiment of the present invention. In the process 300, in block 301, the workflow of a user that includes workflow tasks for the user may be received. In block 302, information regarding expected times to complete each workflow task may be received or may be generated from known information. In block 303, a calendar of a user may be accessed. In block 304, time slots in the calendar that are not already used for a calendar entry may be identified. In block 305, each workflow task may be assigned to an appropriate unused time slot considering the expected times to complete each workflow task. In block 306, calendar entries for the user and the workflow tasks for the user may be inserted together in the calendar of the user.

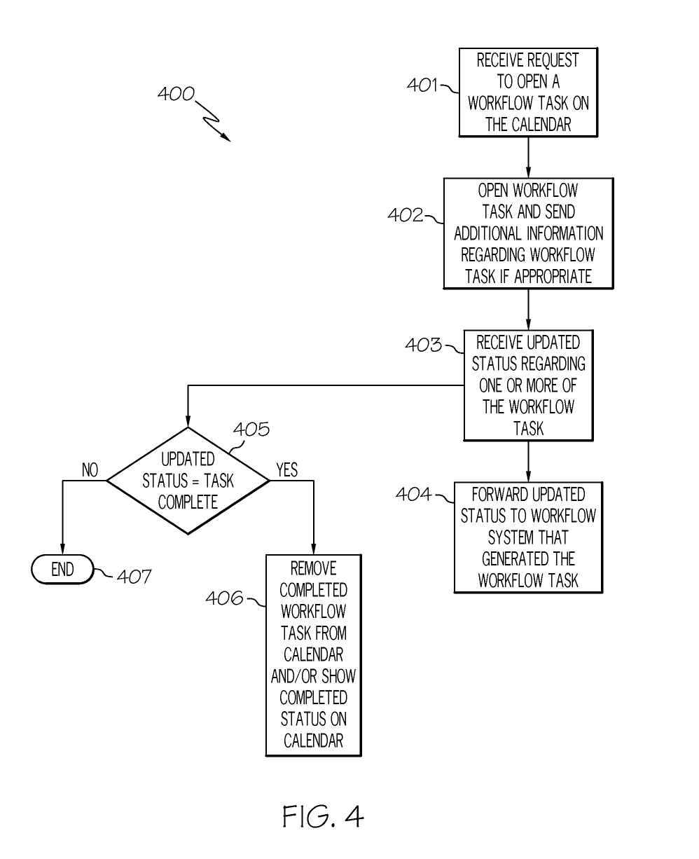

FIG. 4 shows a flowchart of a process for collaborative calendar and workflow management according to a still further exemplary embodiment of the present invention. In the process 400, in block 401, a request to open a workflow task on a calendar may be received. In block 402, the workflow task may be opened and additional information regarding the workflow task may be sent for presentation if appropriate. The additional information may include any of many types of information such as, for example, detailed steps required to complete the workflow task, individuals related to the workflow task, resources needed to perform the workflow task, etc. In block 403, an updated status regarding one or more of the workflow tasks may be received. In block 404, the updated status may be forwarded to a workflow system that generated the workflow task. Further, in block 405, it may be determined if the updated status is that the task has been completed and if so then in block 406, the completed workflow task may be removed from the calendar and/or the completed status shown on the calendar. If the updated status is not that the task is completed, then in block 407, no changes to the calendar may be made.

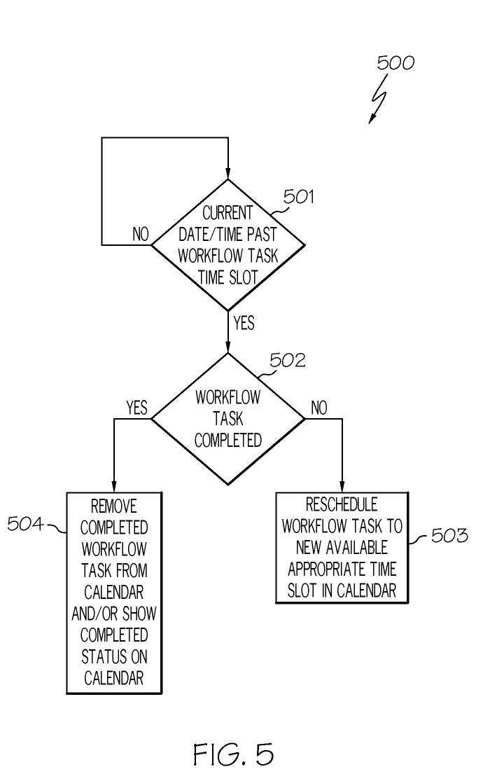

FIG. 5 shows a flowchart of a process for collaborative calendar and workflow management according to a still further exemplary embodiment of the present invention. In the process 500, in block 501, it may be determined whether a current date and time is passed a workflow task time slot and if not, no action is taken. If a current date and time is past a date and time slot associated with the workflow task, then in block 502 it may be determined whether the workflow task has been completed. If the workflow task has not been completed, then in block 503, the workflow task may be rescheduled to a new available and appropriate time slot in the calendar. It may be determined how long it may take to perform the task and an appropriate time slot identified based on this determination to reschedule the workflow task. If the workflow task has been completed, then in block 504, the completed workflow task may be removed from the calendar and/or the completed status may be shown on the calendar.

Therefore, according to embodiments of the present invention, both calendar entries and workflow tasks associated with a user may be inserted together in a calendar. The workflow task may be dynamically updated depending on whether new tasks have been assigned, tasks have been completed, or other reasons.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention has other applications in other environments. This application is intended to cover any adaptations or variations of the present invention. The following claims are in no way intended to limit the scope of embodiments of the invention to the specific embodiments described herein.

What is claimed is:

1. A method, operable on a processing device, for collaborative calendar and workflow management comprising:
receiving, by the processing device, a workflow of a user comprising workflow tasks;
accessing a calendar of the user by the processing device; and
inserting, by the processing device, calendar entries of the user and the workflow tasks together in the calendar of the user.

2. The method according to claim 1, further comprising inserting, by the processing device, the workflow tasks in time slots in the calendar not allocated to the calendar entries.

3. The method according to claim 1, further comprising receiving, by the processing device, the workflow tasks of the user from a workflow system.

4. The method according to claim 1, further comprising sending, by the processing device, an updated status of at least one workflow task on the calendar to a workflow system that generated the at least one workflow task.

5. The method according to claim 1, further comprising receiving, by the processing device, a request to open one of the workflow tasks inserted in the calendar and sending further details related to the one workflow task responsive to the request.

6. The method according to claim 1, further comprising receiving, by the processing device, information of completion of one of the workflow tasks and notifying a workflow system that generated the one workflow task of the completion.

7. The method according to claim 6, further comprising removing, by the processing device, the one of the workflow tasks from the calendar responsive to the receiving information of the completion of the one of the workflow tasks.

8. The method according to claim 1, further comprising rescheduling, by the processing device, one of the workflow tasks to a different time slot in the calendar responsive to a time slot for the one of the workflow tasks expiring before completion of the one of the workflow tasks.

9. The method according to claim 1, further comprising scheduling, by the processing device, a time slot on the calendar for each of the workflow tasks based on an expected time to complete each specific workflow task.

10. The method according to claim 9, further comprising receiving, by the processing device, metadata containing the expected time for each specific workflow task.

11. The method according to claim 10, wherein the metadata is at least one of generated by a modeler/designer of the workflow, customized and generated at deployment of the workflow, or generated from feedback from monitoring a user assigned the workflow task.

12. The method according to claim 9, wherein the scheduling the workflow tasks is dependent on at least one priority associated the workflow.

13. The method according to claim 1, wherein communication to the calendar system from the workflow system is based on at least one of an SMTP message, a SOAP request, a RPC, sending a message, using RMI, using HOP, making a web service call, directly manipulating data/metadata in a database of the calendar system or directly manipulating data/metadata associated with the workflow system.

14. A processing device for collaborative calendar and workflow management comprising:
a network interface, the network interface being configured to receive and send information to a workflow system; and
a processor, the processor configured to receive a workflow of a user comprising workflow tasks, access a calendar of the user, and insert calendar entries of the user and the workflow tasks together in the calendar of the user.

15. The processing device according to claim 14, further comprising the processor configured to receive the workflow tasks of the user from a workflow system.

16. The processing device according to claim 14, further comprising the processor configured to send an updated status of at least one workflow task on the calendar to a workflow system that generated the at least one workflow task.

17. The processing device according to claim 14, further comprising the processor configured to reschedule one of the workflow tasks to a different time slot in the calendar responsive to a time slot for the one of the workflow tasks expiring before completion of the one of the workflow tasks.

18. A computer program product comprising a computer readable storage medium having computer readable program code embodied therewith, the computer readable storage medium comprising:
computer readable program code configured to receive a workflow of the user comprising workflow tasks;
computer readable program code configured to access a calendar of a user by the processing device; and
computer readable program code configured to insert calendar entries of the user and the workflow tasks together in the calendar of the user.

19. The storage medium according to claim 18, further comprising computer readable program code configured to receive the workflow tasks of the user from a workflow system.

20. The storage medium according to claim 18, further comprising computer readable program code configured to send an updated status of at least one workflow task on the calendar to a workflow system that generated the at least one workflow task.
